(19) United States
(12) Patent Application Publication
(10) Pub. No.: US 2014/0071295 A1
(43) Pub. Date: Mar. 13, 2014

(54) SYSTEM AND METHOD FOR OPTICALLY LIFTING LATENT FINGERPRINTS FROM A NON-POLISHED AND/OR NON-FLUORESCING SURFACE

(71) Applicant: LOCKHEED MARTIN CORPORATION, Bethesda, MD (US)

(72) Inventor: Edward Jozef Miesak, Windermere, FL (US)

(73) Assignee: LOCKHEED MARTIN CORPORATION, Bethesda, MD (US)

(21) Appl. No.: 14/022,178

(22) Filed: Sep. 9, 2013

Related U.S. Application Data
(60) Provisional application No. 61/697,913, filed on Sep. 7, 2012.

(51) Int. Cl. G06K 9/00

(52) U.S. Cl. CPC G06K 9/00033
USPC 348/164

(57) ABSTRACT

A system including a light emitting device configured to illuminate a light at a low optical transmission wavelength upon a surface to detect a latent print or a contaminant, and an imaging device configured to operate at the wavelength emitted by the light emitting device to capture an image of the latent print or contaminant, upon the surface, that is visible in a visible spectrum is disclosed. A method and another system are also disclosed.

### CROSS-REFERENCE TO RELATED APPLICATIONS

This application claims the benefit of U.S. Provisional Application No. 61/697,913 filed Sep. 7, 2012, and incorporated herein by reference in its entirety.

### BACKGROUND

Embodiments relate to an imaging system and, more particularly, to a system and method to optically detect a latent print or contaminant upon a surface.

A latent print may be invisible fingerprint impression, footprint impression, or palm print impression left on a surface following surface contact caused by the perspiration on ridges of an individual's skin coming in contact with a surface and leaving perspiration, sebum, waxes, oils, etc. behind, making an invisible or partially visible impression on the surface as a result. Perspiration is known to contain water, salt, amino acids, and oils, which allows impressions to be made. The natural oils of the body, or non-bodily fluids, preserve the print, where the impression left is utterly distinct so that no two humans have the same fingerprints.

Conventional methods for extracting fingerprints usually involve adding chemicals or powders to the print. Such conventional methods can present an immediate dilemma in that they force the investigator to make a decision as to whether to dust for prints versus swabbing for deoxyribonucleic acid (“DNA”) evidence. Either approach results in destroying, or removing, the prints as they are originally found since the prints are no longer on their original surface.

Automatic non-contact latent fingerprint detection systems are also known that avoid the need to add chemicals or powders that can disturb the surface chemicals of the fingerprint. Such systems generally include a single light source, utilize only diffuse reflectance ((reject specular reflection (glare)) and some may even use specular reflection, and are generally limited to fingerprinting the area of one's finger, or an area about that size.

Lifting a latent fingerprint off smooth flat surfaces having a mirror-like surface is most easily done by exploiting scattered light by scattering light off the latent fingerprint into a camera lens or away from the camera lens. Optical detection is usually critically dependent on image contrast. Latent prints are very low contrast objects and therefore using only existing optical techniques when the print is on a rough surface is not practical.

However, depending on the material of the surface to which the latent fingerprint is on, the scattered light from the surface may act as a noise background to the latent fingerprint image. As the surface roughness increases so does the amount of scattered light and hence contributed noise. At some point the noise obscures the image rendering the latent fingerprint invisible. Using low optical transmission to add image contrast allows the user to lift the latent fingerprint off a non-fluorescing, or very weakly fluorescing, roughened surface that has significant amounts of optical scatter.

Entities wishing to detect latent prints would benefit from a system and method which such prints may be detected without damaging the print.

### SUMMARY

Embodiments relate to a system and method to optically detect a latent print or contaminant upon a surface. The system comprises a light emitting device configured to illuminate a light at a low optical transmission wavelength upon a surface to detect a latent print or a contaminant. The system also comprises an imaging device configured to operate at the wavelength emitted by the light emitting device to capture an image of the latent print or contaminant, upon the surface. The captured image illustrates a reflected light image of the latent print or contaminant in a visible spectrum.

The method comprises illuminating a light from a light emitting device at a low optical transmission wavelength on a surface with a latent print or a contamination. The method also comprises capturing an image of a latent print or contaminant with an imaging device operating at the low optical transmission wavelength while the surface is illuminated. The method also comprises producing the image of the surface with the latent print or the contaminant illustrated in a reflected light image in a visible spectrum.

Another system comprises a latent print or contaminant detection system with a light emitting device and imaging device wherein the light emitting device emits a light at a low optical transmission wavelength and the imaging device acquires an image at the low optical transmission wavelength and wherein the acquired image illustrates a reflected light image of a latent print or contaminant in a visible spectrum.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a block diagram representing an embodiment of a system;

FIG. 2 shows a plot illustrating transmission percentage versus wavelength in micrometers of an optical transmission curve;

FIG. 3 shows a plot illustrating transmission percentage versus wavelength at ultraviolet wavelengths of two contaminant materials;

FIG. 4 shows a plot illustrating an embodiment of a plot representing amplitude versus wavelength of a spectral filter output;

FIG. 5 shows an illustration of a fingerprint image optically captured using an embodiment of the system;

FIG, 6 shows an illustration of a fingerprint image optically captured using an embodiment of the system; and

FIG. 7 shows a flowchart of a method.

### DETAILED DESCRIPTION

Embodiments are described herein with reference to the attached figures, wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments are disclosed with respect to latent fingerprints, the embodiments are also applicable to other latent markings or prints as well, such as, but not limited to, a footprint a palm print, etc. Embodiments are also applicable to other surface contaminants as well. As used herein, “latent print” comprises a latent fingerprint and other imprints that may be recognizable to distinguish an entity from another. Latent fingerprints, which are impressions left by the friction ridges of a human finger, may be composed of almost any material, including, but not limited to, grease, oil, sweat, wax, etc. “Latent” as used with respect to fingerprints and/or other prints means a chance or accidental impression left on a surface, regardless of whether visible or invisible at time of deposition. The term “contaminant” is also used herein. This term is not limited as it can also apply to a latent print. Other non-limiting examples of a contaminant may include blood or other body fluids, oils, greases, dusts, dirt, water residue, other particulates, a foreign object, a fracture in a surface, a physical defect in the surface, etc,

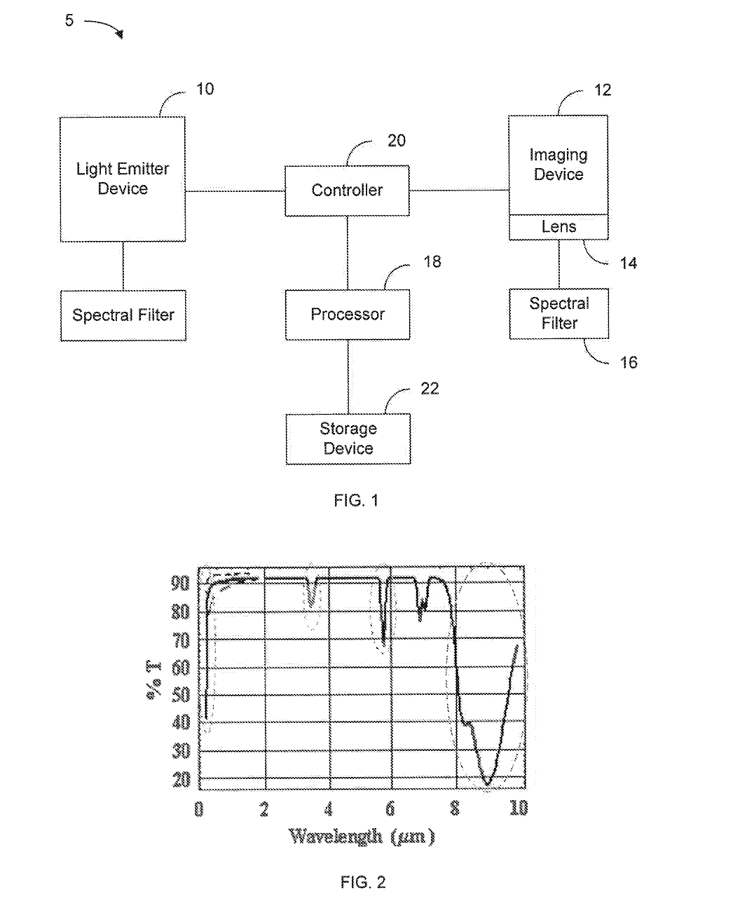

FIG. 1 discloses a block diagram representing an embodiment of a system for optically obtaining information about a latent fingerprint without disturbing a source where the latent fingerprint is located. As illustrated as part of the system 5, a light emitting device 10, or light source, is disclosed. The light source produces an illuminated output which has a low optical transmission through the material which makes up a latent fingerprint. In an embodiment, the wavelength is in the ultraviolet C (“UVC”) region, more specifically, ranging from about 160 nanometers to about 206 nanometers. As used herein “about” may be used interchangeably with “approximately.” Another wavelength region which may be used is a Long Wave Infrared (“LWIR”) portion of an optical spectrum, ranging from 8 micrometers to 15 micrometers. Using material absorption, as disclosed herein, to increase image contrast is paramount because on rough surfaces, scattered light obscures optical detection of latent fingerprints.

FIG. 2 discloses a plot illustrating transmission percentage versus wavelength in micrometers of an optical transmission curve of a particular, or sample of, fingerprint material and is provided to further illustrate the optical transmission regions disclosed herein. Those skilled in the art recognize that other samples of fingerprint material will somewhat resemble this curve, but may differ slightly. Four regions are identified as marked where lower optical transmission exists. The region closest to zero micrometers is in the UVC region. The region between 8 micrometers to 15 micrometers is the LWIR region.

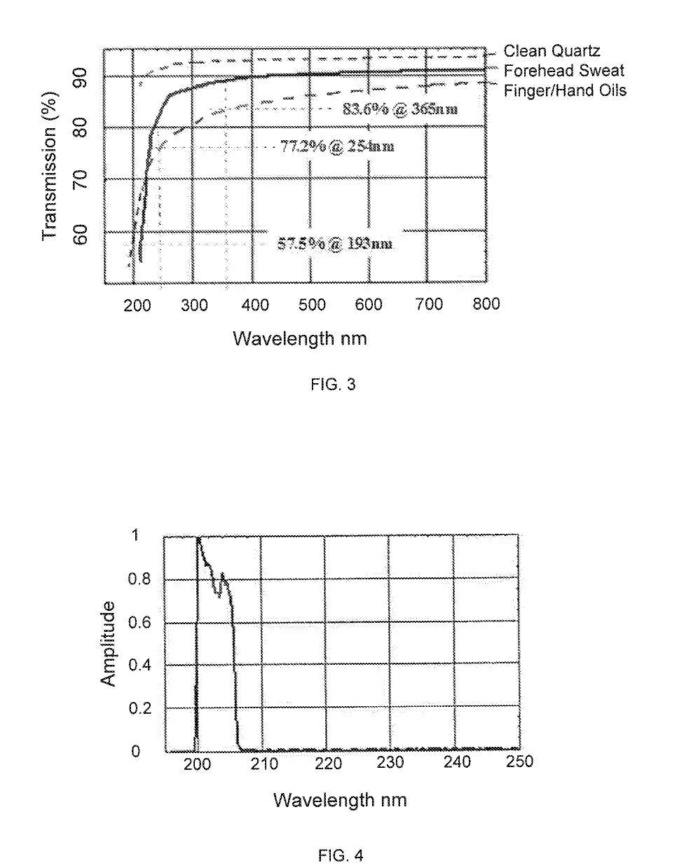

FIG. 3 discloses a plot illustrating transmission percentage versus wavelength at ultraviolet wavelengths of two contaminant materials. Other materials may differ from this illustration, but the type of behavior represented is typical, meaning that with other fingerprint materials, transmission drops as wavelength gets shorter. Image contrast of latent fingerprints is directly linked to their absorption. More specifically, the short wavelength portion of a transmission spectrum is disclosed where absorption of material which makes up the latent fingerprint exceeds background material. As illustrated, optical transmission decreases rapidly as the optical wavelength enters the UVC region, namely, less than 280 nanometers. As illustrated, these plots represent clean quartz, forehead sweat, and oils typically found on an individual's fingers/hands.

Turning back to FIG. 1, an imaging device 12, such as a camera, is also disclosed. The camera 12 captures images at the illuminated wavelength of a light emitted by the light source 10. The camera 12 may be able to view images in the wavelength of the illuminated light as well as in visible wavelengths. The lens 14 on the camera 12 may be a quartz lens, such as, but not limited to, a fifty (50) millimeter quarts lens.

A spectral filter 16 may also be a part of the system 5. Though the term “spectral” is used with filter, this term is used to include a filter with a very high efficiency, very sharp cut-off at wavelengths in the vicinity of 200 nanometers, and does not cease to operate at longer wavelengths. The spectral filter 16 may be applied to, or provided to function with, the light source 10, the imaging device 12, or to both the light source 10 and imaging device 12. Where to apply the spectral filter 16 may depend on a sample of fingerprint material.

FIG. 4 discloses a plot illustrating an embodiment of a plot representing amplitude versus wavelength of the filter. In an embodiment, the filter 16 works in reflection, i.e., the wavelengths desired will reflect off the filter while the wavelengths not wanted will pass through. One feature provided by this filter is that it does not turn on at longer wavelengths. With a maximum transmission greater than ninety percent, there is a sharp cut-off slope on the long wavelength side, at about 206 nanometers.

In one embodiment the spectral filter 16 may be used when fluorescence is an issue with the material composing the latent image and/or a surface upon which the image is placed. The spectral filter 16 will prevent or limit the camera 12 from picking up any fluorescence that may be reflecting from the latent fingerprint.

In an embodiment, the spectral filter 16 may be used to limit visible wavelengths longer than wavelengths of an illuminated light of the light source 10. Thus, in operation, the light spectrum which is able to pass through the filter 16 will match the portion of the spectrum of the light source 10 that has the lowest optical transmission through the fingerprint material. Depending on a type of lens 14 used, the spectral filter 16 may always be used since it will prevent or limit the camera 12 from seeing any wavelengths other than what is produced by the light source 10 in the optical region that corresponds to the lowest optical transmission through the fingerprint material.

A processor 18 is also disclosed. The processor 18 may be used to gather the data associated with the image taken by the camera 12. The processor 18 may also comprise, or be in communication with, a controller 20 and/or a storage device 22. The controller 20 may be used to sync the illumination of the light source 10 with activation, or operation, of camera 12. More specifically, when a user is ready to take an image, activating the camera 12 to take the image is handled by the controller 20 where taking the activation of the camera 12 may be delayed so that the light source 10 has time to illuminate the surface with a desired amount of illumination in advance of the image being taken. Captured images may then be stored in the storage device 22,

In an embodiment, the processor 18 and controller 20 may be a single unit or component. For discussion herein, the combined unit may be referred to as a process controller. The processor controller may also be configured to detect an optical transmission wavelength setting on the light emitting device 10 and then programming the camera 12 to operate at the same wavelength and/or notify a user whether they are operating at the same wavelength or not.

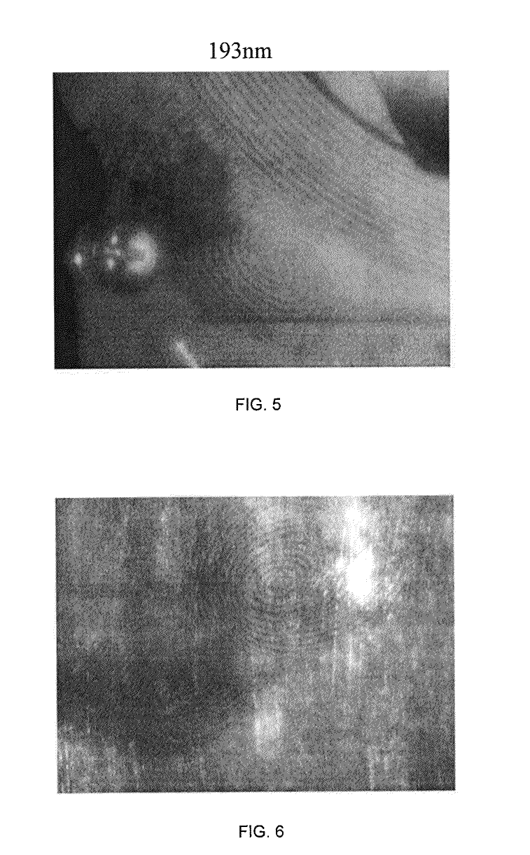

FIG. 5 discloses an illustration of a fingerprint image optically captured using an embodiment of the system. The material upon which the latent fingerprint is placed is a metallic cover of a tape measure. This surface has minimum to no fluorescing. Illuminating a surface with a latent fingerprint at an illumination wavelength of 193 nanometers allowed for the camera, as disclosed above and without a filter, to capture this image. The latent fingerprint is visible due to an increased contrast due to the shorter illuminating wavelength and its associated lower optical transmission through the fingerprint material. Thus, the latent print is visible in a visible spectrum or, the image captures reflected light in the visible spectrum such that latent print is visible in the visible spectrum.

FIG. 6 discloses an illustration of a fingerprint image optically captured using an embodiment of the system. The latent fingerprint is on an unpolished piece of aluminum. When illuminated with at an ultraviolet wavelength of less than 206 nanometers, the camera was able to image two latent fingerprints which are easily detectable in the image.

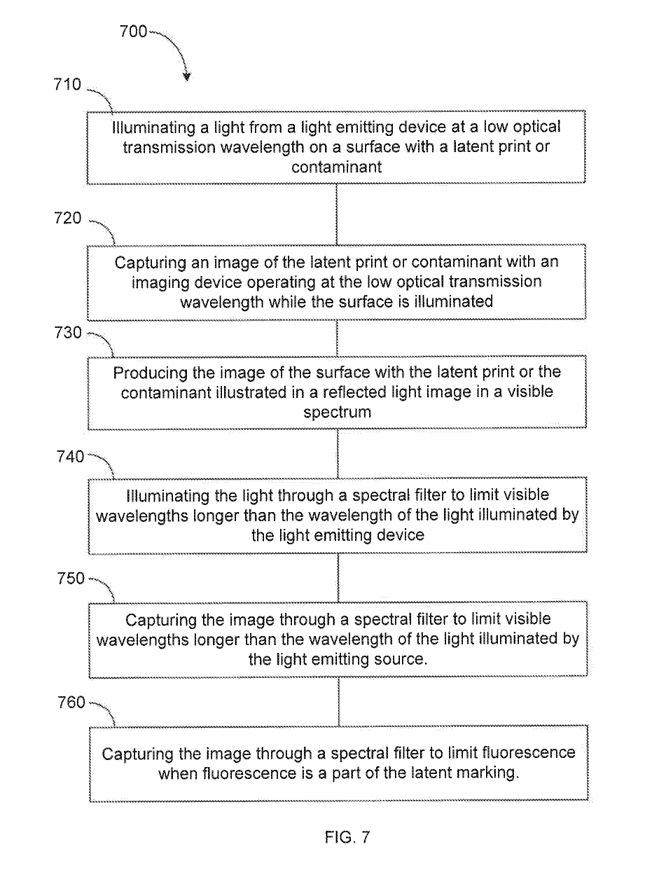

FIG. 7 discloses a flowchart of a method, generally for optically capturing an image without disturbing a source where the latent fingerprint is located. The method 700 may be used to produce the images disclosed above with respect to FIGS. 5 and 6. The method 700 comprises illuminating a light from a light emitting device at a low optical transmission wavelength on a surface with a latent print or a contaminant, at 710. The method also comprises capturing an image of a latent print or contaminant with an imaging device operating at the low optical transmission wavelength while the surface is illuminated, at 720. The method also comprises producing the image of the surface with the latent print or the contaminant illustrated in a reflected light image in a visible spectrum, at 730.

The method 700 may also comprise illuminating the light through a spectral filter to limit visible wavelengths longer than the wavelength of the light illuminated by the light emitting device, at 740. The method may also comprise capturing the image through a spectral filter to limit visible wavelengths longer than the wavelength of the light illuminated by the light emitting device, at 750. The method may also comprise capturing the image through a spectral filter to limit fluorescence when fluorescence is a part of the latent print, at 760.

Though the steps illustrated in the flowchart of the method and provided in a. particular sequence, this sequence is not meant to be limiting as those skilled in the art will recognize that these steps may be performed in any particular order. By applying this method 700 and using the system described herein, the latent image is not disturbed. Thus there is no need to apply dusting, super-glue fuming, and/or other non-optical imaging techniques which result in material coming into direct contact with the latent image.

While various disclosed embodiments have been described above, it should be understood that they have been presented by way of example only, and not limitation. Numerous changes to the subject matter disclosed herein can be made in accordance with the embodiments disclosed herein without departing from the spirit or scope of the embodiments. in addition, while a particular feature may have been disclosed with respect to only one of several implementations, such feature may be combined with one or more other features of the other implementations as may be desired and advantageous for any given or particular application.

Therefore, the breadth and scope of the subject matter provided herein should not be limited by any of the above explicitly described embodiments. Rather, the scope of the embodiments should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Thus, while embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered.

What is claimed is:

1. A system comprising:
a light emitting device configured to illuminate a light at a low optical transmission wavelength upon a surface to detect a latent print or a contaminant; and
an imaging device configured to operate at the wavelength emitted by the light emitting device to capture an image of the latent print or contaminant, upon the surface;
wherein the captured image illustrates a reflected light image of the latent print or contaminant in a visible spectrum.

2. The system according to claim 1, wherein the surface comprises a roughness which creates background noise when scattered ordinary light is provided to illuminate the surface,

3. The system according to claim 1, wherein the latent print comprises a latent fingerprint, a palm print, or a footprint.

4. The system according to claim 1, wherein the contaminant comprises a foreign object, a particulate, a fracture in the surface or a physical defect in the surface.

5. The system according to claim 1, further comprising a spectral filter configured to function with the imaging device and/or the light emitting device to limit visible wavelengths longer than the wavelength of the light illuminated by the light emitting device.

6. The system according to claim 1, further comprising a spectral filter configured to function with imaging device to limit fluorescence when fluorescence is a part of a material of the latent print or contaminant.

7. The system according to claim 1, wherein the low optical transmission wavelength comprises a wavelength that is no longer than approximately 206 nanometers.

8. The system according to claim 1, wherein the low optical transmission wavelength comprises a wavelength between approximately 8 micrometers and approximately 10 micrometers.

9. A method comprising:
illuminating a light from a light emitting device at a low optical transmission wavelength on a surface with a latent print or a contaminant;
capturing an image of a latent print or contaminant with an imaging device operating at the low optical transmission wavelength while the surface is illuminated; and
producing the image of the surface with the latent print or the contaminant illustrated in a reflected light image in a visible spectrum.

10. The method according to claim 9, further comprising illuminating the light through a spectral filter to limit visible wavelengths longer than the wavelength of the light illuminated by the light emitting device.

11. The method according to claim 9, further comprising capturing the image through a spectral filter to limit visible wavelengths longer than the wavelength of the light illuminated by the light emitting device.

12. The method according to claim 10, wherein the spectral filter limits a wavelength illuminated to less than approximately 206 nanometers and/or at a range of approximately 8 micrometers to approximately 10 micrometers.

13. The method according to claim 11, wherein the spectral filter limits the wavelengths captured to less than 206 nanometers or at a range of approximately 8 micrometers to approximately 10 micrometers.

14. The method according to claim 9, further comprising capturing the image through a spectral filter to limit fluorescence when fluorescence is a part of the latent print or the surface.

15. A system comprising a latent print or contaminant detection system with a light emitting device and imaging device wherein the light emitting device emits a light at a low optical transmission wavelength and the imaging device acquires an image at the low optical transmission wavelength and wherein the acquired image illustrates a reflected light image of a latent print or contaminant in a visible spectrum.

16. The system according to claim 15, wherein the low optical transmission wavelength is no longer than approximately 206 nanometers.

17. The system according to claim 15, wherein the wavelength is between approximately 8 micrometers and approximately 10 micrometers.

18. The system according to claim 15, further comprising a spectral filter configured to limit visible wavelengths longer than the wavelength of the light illuminated by the light emitting device.

19. The system according to claim 15, further comprising a spectral filter configured to limit fluorescence when fluorescence is a part of a material of the latent print or contaminant.

20. The system according to claim 15, further comprising a process controller configured to sync the transmission wavelength of the light emitting device and imaging device or to notify a user of the transmission wavelength of the light emitting device and the imaging device.
